(19) United States
(12) Patent Application Publication
(10) Pub. No.: US 2004/0254984 A1
(43) Pub. Date: Dec. 16, 2004

(54) System and method for coordinating cluster serviceability updates over distributed consensus within a distributed data system cluster

(75) Inventor: Darpan Dinker, Santa Clara, CA (US)

Correspondence Address: MEYERTONS, HOOD, KIVLIN, KOWERT & GOETZEL, P.C., P.O. BOX 398, AUSTIN, TX, 78767-0398, US

(73) Assignee: Sun Microsystems, Inc, Santa Clara, CA (US)

(21) Appl. No.: 10/460,513

(22) Filed: Jun. 12, 2003

(51) Int. Cl. G06F 15/16

(52) U.S. Cl. 709/205

(57) ABSTRACT

A distributed data system cluster may include several nodes and an interconnect coupling the nodes. Each node may include a consensus module and a serviceability module. In response to receiving a request to perform a serviceability update from a serviceability module, a consensus module may be configured to send a vote request to the consensus modules included in each of the other nodes. Each consensus module may be configured to send a vote to each other consensus module in response to receiving the vote request. A consensus module in one may also be configured to cause a serviceability module included in the same node to perform the serviceability update dependent on whether a quorum is indicated by the votes received from the consensus modules in the other nodes.

### BACKGROUND OF THE INVENTION

1. Field of the Invention

The present invention relates to distributed data systems and, in particular, to coordinating updates within a distributed data system cluster.

2. Description of Related Art

Cooperating members, or nodes, of a distributed data system may form a cluster to provide transparent data access and data locality for clients, abstracting the possible complexity of the data distribution within the cluster away from the clients. Nodes may be servers, computers, or other computing devices. Nodes may also be computing processes, and thus multiple nodes may exist on the same server, computer, or other computing device.

A cluster may provide high availability by replicating data on one or more of the nodes included in the cluster. Upon failure of a node in the cluster, the cluster may repair the failure through a “self-healing” process to maintain high availability. The repair typically involves duplicating data that was stored on the failed node from a non-failed node, which also stores that data, onto another cluster node. Thus, the healing process ensures that a desired number of copies of the data remain in the cluster. For example, two cluster nodes may store duplicates of the same data. In response to the failure of one of these two nodes, the non-failed node may duplicate the data onto a third node to ensure that multiple copies of data remain in the cluster and to maintain high availability.

In many distributed data system clusters, it is inherently difficult to coordinate the nodes within the cluster. For example, if an application served by a cluster of application servers is upgraded, it is often difficult to synchronously upgrade the version of the application served by each node within the cluster. However, given that a cluster should appear as monolithic as possible to an external client, it is desirable that the change be as synchronous as possible. This desire may be frustrated when protocols allow some nodes to effect the change before others and/or require a change effected at some nodes to be rolled back if other nodes are unable to comply. Additionally, in systems in which changes are performed using distributed transactions over TCP (Transmission Control Protocol), the length of time needed to effect the change may be undesirably slow. This length of time may increase with the number of nodes in the cluster. Accordingly, it is desirable to provide a new technique for updating nodes within a cluster.

### SUMMARY

Various systems and methods for performing cluster serviceability updates over distributed consensus are disclosed. In one embodiment, a method involves: receiving a request to perform a cluster serviceability update; requesting a consensus corresponding to the cluster serviceability update from nodes included in the cluster; each of the nodes communicating at least one vote corresponding to the cluster serviceability update to each other node; and each node selectively performing the cluster serviceability update in response to receiving one or more votes from each other node dependent upon whether a quorum specified in the cluster serviceability update is indicated in the received votes. The quorum may be specified as a group and/or number of nodes required to perform the serviceability update.

The request to perform the cluster serviceability update may specify a task to be performed and a quorum to be reached before performing the task. The quorum may require agreement from fewer than all of the nodes. The request to perform the cluster serviceability update may also specify a list of participating nodes within the cluster. The list of participating nodes may identify fewer than all nodes included within the cluster.

Performing the cluster serviceability update may involve enabling or disabling an application served by each of the nodes. Alternatively, performing the cluster serviceability update may involve updating cluster membership information maintained at each of the nodes.

One embodiment of a distributed data system cluster may include several nodes and an interconnect coupling nodes. Each node may include a consensus module and a serviceability module. In response to receiving a request to perform a serviceability update from a serviceability module, a consensus module may be configured to send a vote request to the consensus modules included in each of the other nodes. Each consensus module may be configured to send a vote to each other consensus module in response to receiving the vote request. A consensus module in one may also be configured to cause a serviceability module included in the same node to perform the serviceability update dependent on whether a quorum is indicated by the votes received from the consensus modules in the other nodes.

One embodiment of a device for use in a distributed data system cluster may include a network interface configured to send and receive communications from several nodes; a consensus module; and a serviceability module coupled to communicate with the consensus module. In response to receiving a request to perform a serviceability update from the serviceability module, the consensus module may be configured to send a vote request to each of the nodes via the network interface. In response to receiving votes from the nodes, the consensus module may be configured to selectively send an acknowledgment or denial of the request to perform the serviceability update to the serviceability module dependent on whether a quorum is indicated by the received votes.

The consensus module may also be configured to send a vote to each of the nodes via the network interface in response to sending the vote request. If the received votes indicate the quorum, the consensus module may be configured to instruct the serviceability module to perform the serviceability update.

### BRIEF DESCRIPTION OF THE DRAWINGS

A better understanding of the present invention can be obtained when the following detailed description is considered in conjunction with the following drawings, in which:

FIG. 1A illustrates a distributed data system cluster according to one embodiment.

FIG. 1B illustrates a distributed data system according to one embodiment.

FIG. 1C shows a cluster of application servers in a three-tiered environment, according to one embodiment.

FIG. 1D is a block diagram of a device that may be included in a distributed data system cluster according to one embodiment.

FIG. 2A illustrates nodes in a distributed data system cluster performing a serviceability task over distributed consensus, according to one embodiment.

FIG. 2B illustrates a consensus module that may be included in a node, according to one embodiment.

FIG. 2C shows a serviceability module that may be included in a node, according to one embodiment.

FIG. 3 illustrates a method of performing a cluster serviceability update over distributed consensus, according to one embodiment.

While the invention is described herein by way of example for several embodiments and illustrative drawings, those skilled in the art will recognize that the invention is not limited to the embodiments or drawings described. It should be understood that the drawings and detailed description are not intended to limit the invention to the particular form disclosed but, on the contrary, the intention is to cover all modifications, equivalents, and alternatives falling within the spirit and scope of the present invention as defined by the appended claims. The headings used are for organizational purposes only and are not meant to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION OF EMBODIMENTS

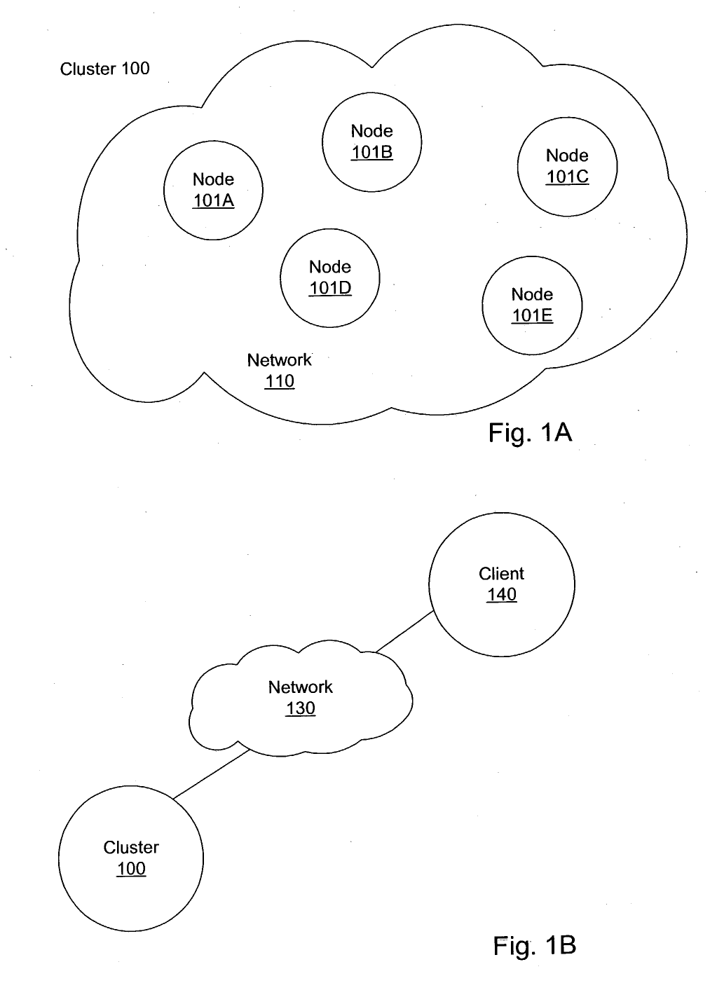

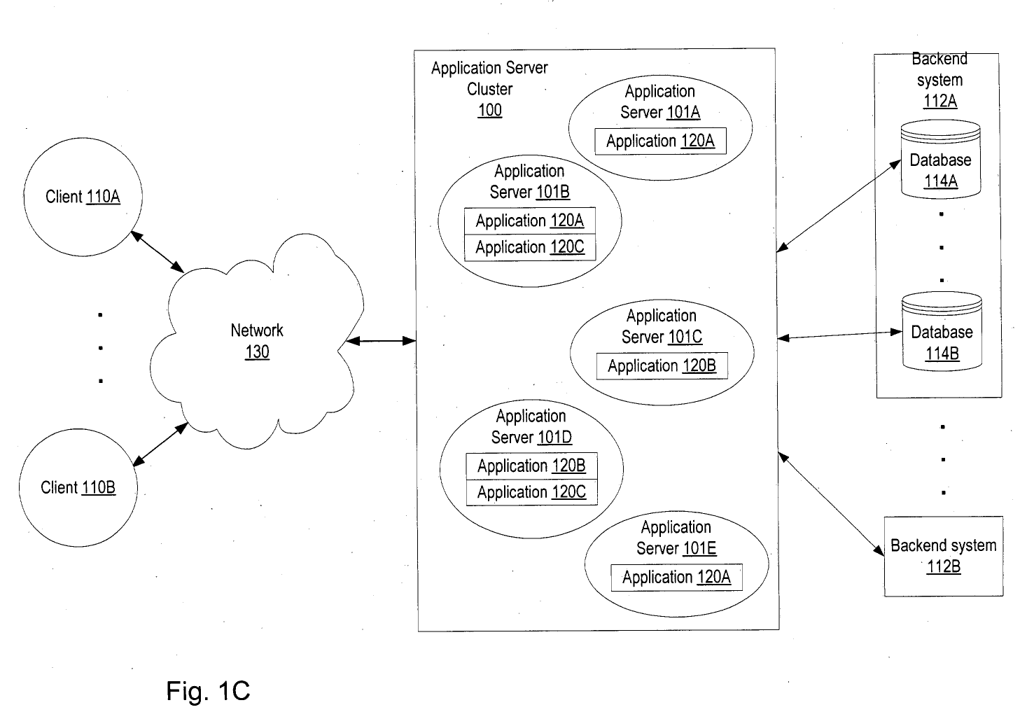

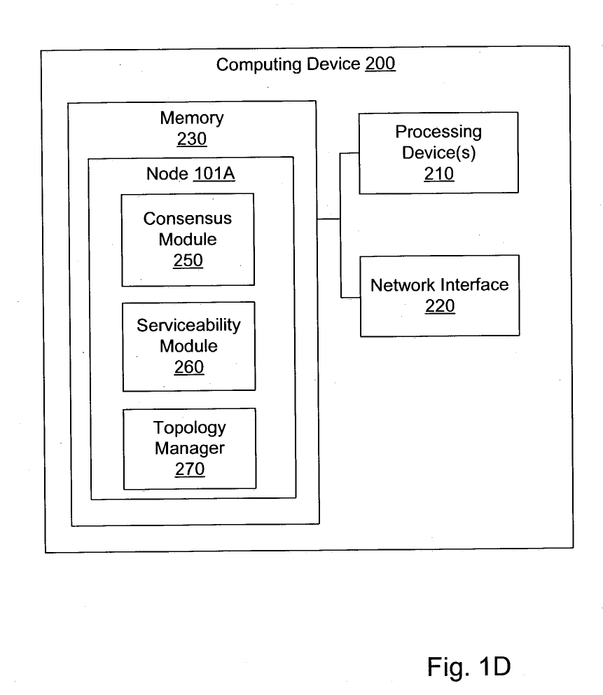

FIG. 1A illustrates one embodiment of a cluster 100 that includes nodes 101A-101E. Cluster 100 is an example of a distributed data system cluster in which data is replicated on several nodes. As used herein, a “node” may be a stand-alone computer, server, or other computing device, as well as a virtual machine, thread, process, or combination of such elements. A “cluster” is a group of nodes that provide high availability and/or other properties, such as load balancing, failover, and scalability. For example, replicating data within a cluster may lead to increased availability and failover with respect to a single node failure. Similarly, subsets of a cluster's data may be distributed among several nodes based on subset size and/or how often each subset of data is accessed, leading to more balanced load on each node. Furthermore, a cluster may support the dynamic addition and removal of nodes, leading to increased scalability.

Nodes 101A-101E may be interconnected by a network 110 of various communication links (e.g., electrical, fiber optic, and/or wireless links). Cluster 100 may include multiple computing devices that are coupled by one or more networks (e.g., a WAN (Wide Area Network), the Internet, or a local intranet) in some embodiments. In other embodiments, a cluster 100 may include a single computing device on which multiple processes are executing. Note that throughout this disclosure, drawing features identified by the same numeral followed by a letter (e.g., nodes 101A-101E) may be collectively referred to using the numeral alone (e.g., nodes 101). Note also that in other embodiments, clusters may include different numbers of nodes than illustrated in FIG. 1A.

Data may be physically replicated in several different storage locations within cluster 100 in some embodiments. Storage locations may be locations within one or more storage devices included in or accessed by one or more servers, computers, or other computing devices. For example, if each node 101 is a separate computing device, each data set may be replicated in different storage locations included in and/or accessible to at least one of the computing devices. In another example, data may be replicated between multiple nodes implemented on the same server (e.g., each process may store its copy of the data within a different set of storage locations to which that process provides access). Storage devices may include disk drives, tape drives, CD-ROM drives, memory, registers, and other media from which data may be accessed. Note that in many embodiments, data may be replicated on different physical devices (e.g., on different disk drives within a SAN (Storage Area Network)) to provide heightened availability in case of a physical device failure.

The way in which data is replicated throughout cluster 100 may be defined by cluster 100's replication topology. A replication topology is typically a static definition of how data should be replicated within a cluster. The topology may be specified by use of or reference to node identifiers, addresses, or any other suitable node identifier. The replication topology may include address or connection information for some nodes.

As shown in FIG. 1B, cluster 100 may be configured to interact with one or more external clients 140 coupled to the cluster via a network 130. Note that nodes 101 within cluster 100 may also be clients of nodes within cluster 100. During the interaction of the cluster 100 with clients, clients may send the cluster 100 requests for access to services provided by and/or data stored in the cluster 100. For example, a client 140 may request read access to data stored in the cluster 100. Similarly, the client 140 may request write access to update data already stored in the cluster 100 or to create new data within the cluster 100.

Client requests received by a node 101 within cluster may be communicated to a node that is responsible for responding to those client requests. For example, if the cluster is homogeneous (i.e., each node is configured similarly) with respect to the data and/or services specified in the client request, any node within the cluster may appropriately handle the request. However, load balancing or other criteria such as sticky routing (in which the same node 101 communicates with a client for the duration of a client-cluster transaction) may further select a particular one of the nodes 101 to which each request should be routed. In a heterogeneous cluster, certain client requests may only be handled by a specific subset of one or more cluster nodes. As in a homogeneous cluster, however, load balancing and other concerns may also further restrict which nodes a particular client request may be routed to. Note that in some situations, a client request may be handled by the first node 101 within the cluster that receives the client request.

FIG. 1C illustrates an application server cluster 100 in a three-tier environment, according to one embodiment. The three-tier environment is organized into three major parts, each of which may be distributed within a networked computer system. The three parts (tiers) may include: one or more clients 110, a cluster 100 of application server nodes 101A-101E, and one or more backend systems 112, which may contain one or more databases 114 along with appropriate database management functions. In the first tier, a client 110 may be a program running on a user's computer that includes a graphical user interface, application-specific entry forms, and/or interactive windows for interacting with an application. An exemplary client 110 may be a web browser that allows a user to access the Internet.

In the second tier, an application server node 101 may be a program that provides the application logic 120, such as a service for banking transactions or purchasing merchandise, for the user of a client 360. A server node 101 may be executing on one or more computing devices, or more than one server node may execute on the same computing device. One or more client systems 110 may be connected to one or more server nodes 101 via a network 130. An exemplary network 130 of this type is the Internet.

The third tier of a three-tier application may include one or more backend systems 112. If data accessed in response to a client request is not available within a server 101, a component of that server (e.g., an enterprise Java bean (EJB)) may request the data from a backend system 112. A backend system 112 may include one or more databases 114 and programs that facilitate access to the data those databases 114 contain. A connection between the server 130 and a backend database 114 may be referred to as a database connection.

In FIG. 1C, certain application server nodes within the cluster 100 include the same application logic, while other application server nodes include different application logic. For example, nodes 101A, 101B, and 101E all include application 120A. Similarly, nodes 101C and 101D include application 120B. Nodes 101B and 101C include application 120C. Accordingly, cluster 100 is heterogeneous with respect to the applications served by each node. The homogeneous nodes that serve the same applications should application appear to be a monolithic entity to clients 110 accessing those applications. For example, each time a particular client communicates with cluster 100, a different node 101 may respond to the client. However, to the client, it will seem as if the client is communicating with a single entity. In order to provide this consistency between nodes 101 within the cluster 100, serviceability updates that affect the configuration, serviceability, and/or administration of any of the nodes 101 may be performed over distributed consensus.

Performing a cluster serviceability update (i.e., an update affecting the configuration, administration, and/or serviceability of the nodes within the cluster) over distributed consensus may effect the serviceability update at all participating nodes if a quorum is reached or at none of the participating nodes if a quorum is not reached so that a monolithic view of the participating nodes is maintained. For example, if a system administrator of cluster 100 decides to upgrade application 120A, the system administrator may request several cluster serviceability updates, such as updates to disable the current version of application 120A, to deploy a new version of the application 120A, and to enable the new version of application 120A. Each serviceability update request may be performed over distributed consensus at the participating nodes. A consensus layer within the cluster may operate to determine whether a quorum (e.g., whether all nodes currently serving application 120A are currently able to disable application 120A) exists within the cluster for each serviceability update. If a quorum does not exist, none of the participating nodes 101A, 101B, and 101E may perform the serviceability update. If a quorum exists, however, each participating node may perform the serviceability update.

FIG. 1D illustrates an exemplary computing device that may be included in a distributed data system cluster according to one embodiment. Computing device 200 includes one or more processing device(s) 210 (e.g., microprocessors), a network interface 220 to allow computing device 200 to communicate with other computing devices via network 110, and a memory 230. In some embodiments, device 200 may itself be a node (e.g., a processing device such as a server) within a distributed data system cluster in some embodiments. In other embodiments, one or more of the processes executing on device 200 may be nodes 101 within a distributed data system cluster 100. In the illustrated example, device 200 includes node 101A (e.g., node 101A may be a process stored in memory 230 and executing on one of processing devices 210). Network interface 170 allows node 101A to send and receive communications from clients 140 and other nodes 101 implemented on other computing devices. In many embodiments, computing device 200 may include more than one node 101.

Node 101A includes a consensus module 250, a serviceability module 260, and a topology manager 270. Topology manager 270 tracks the topology of the cluster 100 that includes node 101A. Other nodes 101 within cluster 100 may include similar topology managers. The topology manager 270 may update the cluster topology in response to changes in cluster membership. Network interface 170 may notify topology manager 160 whenever changes in cluster membership (i.e., the addition and/or removal of one or more nodes within cluster 100) are detected. Topology manager 160 may also respond to the dynamic additions and/or departures of nodes 101 in cluster 100 by performing one or more operations (e.g., replicating data) in order to maintain a specified cluster configuration.

Topology manager 270 may also track information about the configuration of each node currently participating in the cluster 100. For example, if data is distributed among the nodes 101, the topology manager 270 may track which nodes store which data. Similarly, if certain nodes 101 are configured as application servers, the topology manager 270 may track which nodes 101 are configured to serve each application. This information may be used to route client requests received by node 101A (via network interface 220) to other nodes within the cluster, if needed.

Serviceability module 260 is configured to perform a serviceability update. A serviceability update includes a cluster configuration, administration, and/or serviceability task. A serviceability update should be contrasted to updates, such as requests to update a data in a database, performed as part of the normal operation of a cluster application during cluster interaction with clients. Example serviceability updates include those involved in: starting a cluster, stopping a cluster, performing an online restart of a cluster, enabling an application to be served by a node, disabling an application served by a node, starting a group of instances within the cluster, stopping a group of instances within a cluster, defining a cluster, configuring across a cluster, adding an instance to a cluster, removing an instance from a cluster, configuring the locale for a cluster, configuring an instance within the cluster, removing a cluster, deploy an application to a cluster, un-deploy an application from a cluster, perform an online upgrade of external components, perform an online upgrade of an application served by a cluster, perform an online upgrade of a server included in the cluster, enable or disable cluster-wide failover for a particular service (e.g., Web container failover), initialize and configure a failover service, select a persistence algorithm to be used by one or more nodes within a cluster, configure a cluster-wide session timeout, configure session cleanup services within the cluster, schedule dynamic reconfiguration of the cluster, select a load balancing algorithm to be used within the cluster, configure a health check mechanism within the cluster, manage server instances (e.g., by enabling, disabling, and/or toggling server instances), and/or transitioning between HTTP and HTTPs. Topology manager 270 is an exemplary type of serviceability module 260 that performs serviceability updates to update the cluster topology of a cluster. Note that multiple serviceability modules 260 may be included in a node 101.

Some serviceability modules 260 may perform the same update (e.g., enabling failover) as other serviceability modules 260 but at different granularities (e.g., cluster-wide level, application level, or module level). Some serviceability modules 260 may perform many related updates. For example, a serviceability module that handles online upgrades may perform updates related to handling online upgrades with potential version incompatibility, online server upgrades, online application upgrades, online operating system upgrades, online Java VM upgrades, and/or online hardware upgrades.

Consensus module 250 allows a node 101 to participate in distributed consensus transactions within cluster 100. Consensus module 250 may receive requests from a serviceability module 260 requesting that a serviceability update be performed by serviceability modules in one or more nodes within the cluster dependent on a quorum of cluster nodes being available to perform the specified serviceability update. A quorum specifies a group and/or number of nodes required to perform the serviceability update. For example, a quorum may be specified as “the five nodes that serve application X.” The specified number of nodes for a quorum may equal the total number of participating nodes in situations in which all participating nodes need to agree (e.g., five out of the five nodes that serve application X). In many situations, however, fewer than all of the participating nodes may be involved in a quorum (e.g., at least three out of the five nodes that serve application X). Furthermore, a quorum may involve a condition. For example, a quorum may be specified as “the three nodes having the lowest load of the five nodes that serve application X.”

In response to receiving a request from a serviceability module 260, the consensus module 250 may interact with consensus modules 250 within other nodes 101 to perform a distributed consensus transaction. Performance of the distributed consensus transaction involves each participating node determining whether a quorum exists and, if so, the participating nodes included in the quorum performing the specified serviceability update. Upon completion of the distributed consensus transaction, the consensus module 250 may return an acknowledgement or a denial of the request to the initiating serviceability module 260. Acknowledgement of the request indicates that a quorum was reached within the cluster and that the requested serviceability update has been performed. Denial indicates that a quorum was not reached and that the requested serviceability update has not been performed. In response to a failed serviceability request, a serviceability module 260 may retry a failed serviceability request and/or generate an error message to a system administrator.

Through the use of consensus modules 250, cluster serviceability (the performance of cluster administration, configuration, and serviceability tasks) may be layered over distributed consensus. A system administrator may initiate a cluster serviceability update via a serviceability module 260, and the underlying consensus modules 250 in the nodes involved in the serviceability update may ensure that the serviceability update is only performed if a quorum is reached. The consensus module 250 in the initiating node then returns an acknowledgement or denial of the serviceability update to the serviceability module 260, which may in turn provide the acknowledgement or denial to the system administrator (e.g., via a display device such as a monitor coupled to computing device 200).

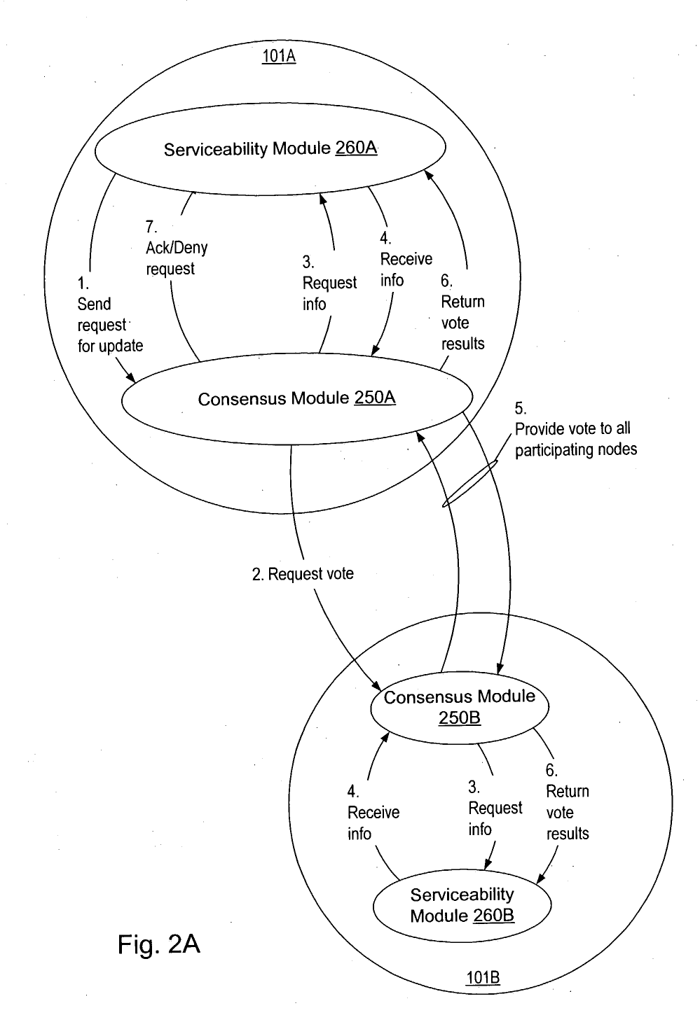

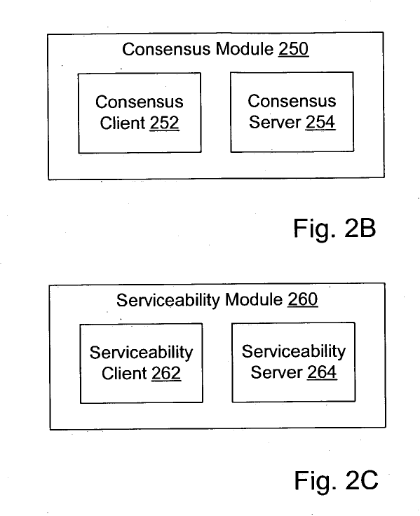

FIG. 2B illustrates how communications may be passed between two nodes 101A and 101B that are participating in a serviceability update over distributed consensus. As shown, node 101A includes a serviceability module 260A, and a consensus server 250A. Node 101B includes a consensus module 250B and a serviceability module 260B. The communication link between the two nodes may be implemented according to various protocols, such as TCP (Transmission Control Protocol) or a multicast protocol with guaranteed message ordering. In some embodiments, a cluster coupled by such a communication link may implement a serviceability update over distributed consensus more quickly than the serviceability update could be implemented using traditional distributed transactions.

The serviceability module 260A in node 101A receives a request for a serviceability update (e.g., from a system administrator) to the cluster. The serviceability module 260A responsively communicates the request for the serviceability update to a consensus module 250A within the same node (as indicated at “1: Send request for update”). The request for the serviceability update may identify the nodes that will participate in the consensus (in this example, nodes 101A and 101B), indicate the quorum required to perform an update, and identify the serviceability update to be performed (e.g., disabling or enabling an application served by the participating nodes).

In response to receiving a request for a serviceability update over distributed consensus from a serviceability module 260A, the consensus layer (i.e., the consensus modules in the participating nodes) within the cluster causes the serviceability update to be performed if a quorum is reached and acknowledges or denies the serviceability update (as indicated at “7: Ack/Deny Request”) based on whether the quorum is reached.

As shown in the illustrated example, the consensus layer may cause the serviceability update by sending communications to consensus modules 250 in each participating node 101A and 101B. Here, the consensus module 250A first communicates the information in the request for the serviceability update to the other consensus module 250B as a vote request (as indicated at “2: Request Vote”). The consensus module 250A may communicate the vote request in a variety of different ways. For example, in one embodiment, a reliable multicast protocol may be used to send the vote request to each participating node. In some embodiments, the consensus module 250A may broadcast the vote request to all nodes within the cluster. Nodes that are not identified as participating nodes in the vote request may ignore the vote request. Other embodiments may communicate the vote request to all of the participating nodes according to a ring or star topology.

In response to receiving a vote request, a consensus module 250 may request information (as indicated at “3: Request Info”) needed to generate the node's vote from a serviceability module 260. For example, if the serviceability update involves disabling an application served by the serviceability module 260, the consensus module 250 may request information indicating whether the serviceability module 260 can disable the application.

Based on the information (received at “4: Receive info”), the consensus modules 250 each generate a vote, which may include both information as to whether the consensus module's node 101 can perform the specified serviceability update and/or information necessary to determine whether a quorum exists. For example, if a serviceability update involves enabling an application on three out of five nodes, the consensus module 250B may communicate with the serviceability module 260B to determine whether that particular node 101B can enable that application and any other information, such as the current load on that node 101B, that is relevant to determining which nodes should form the quorum. If cluster membership is being determined via distributed consensus, each consensus module 250B may communicate with a topology manager 270 included in the same node to determine which nodes its node is coupled to. The consensus module 150B may then include this information in its vote. Thus, each vote may include information identifying the voting node's neighboring nodes (neighboring nodes may be defined according to a communication topology). The consensus module 250B may then send the vote (e.g., using a reliable multicasting protocol) to all of the other participating nodes in the cluster (as indicated at “5: Provide vote to all participating nodes”). The consensus layer may implement communications in such a way that votes may be retried and/or cancelled in certain situations.

Accordingly, each consensus module 250 may receive votes from each of the other participating nodes in the cluster. Based on the information in all of the received votes and the vote generated by that consensus module 250, a consensus module 250 may independently determine whether a quorum exists. For example, if the votes received by consensus module 250A indicate that node 101B and node 101A are both able to perform the serviceability update, and if node 101B and node 101A's agreement establishes a quorum, then consensus module 250A may communicate the vote results to the serviceability module 260A in order to effect the serviceability update. Similarly, based on the vote generated for node 101B and the vote received from 101A, consensus module 250B may determine whether a quorum exists and selectively effect the serviceability update in node 101B. Note that a consensus module within each node may independently determine whether a consensus is reached without relying on another node to make that determination. Additionally, note that no node performs the serviceability update until that node has determined whether a quorum exists.

Determining whether a quorum exists and which nodes are part of the quorum (i.e., which nodes should perform the serviceability update) may involve looking at various information included in the votes. For example, a serviceability update may involve enabling an application on three out of five nodes and each node's vote may indicate (a) whether that node can enable the application and (b) the current load on that node. A quorum exists if at least three of the five participating nodes can enable the specified application. If more than three nodes can enable the specified application, the current load information for each node may be used to select the three nodes that should actually enable the application. In one such embodiment, each consensus module 250 may determine whether its node should enable the application based on whether its node is one of the three nodes having the lowest load out of the group of nodes that can perform the serviceability update.

The consensus module 250 may use various different methodologies to determine whether a quorum exists. For example, if the consensus methodology is designed to be fault tolerant, each node may generate and send votes several times in order to participate in several rounds of voting prior to determining whether a quorum exists. In other embodiments, however, a single round of votes may be used for this determination. In some embodiments, the methodology used by each consensus module 250 to determine consensus may still determine whether a quorum exists and appropriately notify the serviceability layer even if one or more of the participating nodes or processes fail during the voting process. For example, each consensus module 250 may be programmed to continue with the voting process even if a node fails to vote.

In addition to communicating the vote results to the appropriate serviceability module 260 (as indicated at “6: Return vote results”), each consensus module 250 (or at least the consensus module 250A in the initiating node 101A) may acknowledge or deny the serviceability update to the initiating serviceability module 250A based on the vote results.

FIG. 2B shows a block diagram of one embodiment of a consensus module 250. In this embodiment, the consensus module 250 includes a separate client 252 and server 254. The consensus server 254 may receive a request for a serviceability update over distributed consensus from a serviceability module 260 (e.g., at 1 in FIG. 2A) and acknowledge or deny the serviceability update upon success or failure of the vote (e.g., at 7 in FIG. 2A). In some embodiments, the consensus server 254 may also be configured to cancel and/or retry a vote request. For example, in response to a failed vote, the consensus server 254 may be configured to retry the vote request one or more times before denying the serviceability update to the serviceability module 260.

The consensus server 254 may request votes from each consensus client 252 (e.g., at 2 in FIG. 2A). In response to receiving a vote request from a consensus server 254, each consensus client 252 may generate a vote (e.g., by requesting and receiving information from a serviceability module 260 within the same node, as shown at 3 and 4 in FIG. 2A) and send the vote (e.g., as shown at 5 in FIG. 2A) to each other consensus client participating in the distributed consensus. Upon receiving votes from other consensus clients, a consensus client 252 may determine whether a quorum is indicated in the received vote and/or whether its node is part of the quorum. If a quorum is indicated, the consensus client 252 may effect the serviceability update in its node (e.g., by providing the vote results to the serviceability module 260 in the same node, as shown at 6 in FIG. 2A). A consensus client 252 may also return the vote results to the consensus server 254, allowing the consensus server to acknowledge or deny the serviceability update.

FIG. 2C illustrates one embodiment of a serviceability module 260. In this embodiment, the serviceability module 260 includes a serviceability client 262 and a serviceability server 264. The serviceability server 264 may be configured to detect a request for a serviceability update over distributed consensus (e.g., in response to a system administrator entering a command specifying such a serviceability update). The serviceability server 264 may responsively communicate the request for the serviceability update to a consensus module 250 (e.g., as indicated at 1 in FIG. 2A). In response to the consensus module acknowledging or denying the serviceability update, the serviceability server 264 may provide this information to a user (e.g., by displaying text corresponding to the acknowledgement or denial of the serviceability update on a monitor).

The serviceability client 262 may provide information to the consensus module in response to the consensus module's queries (e.g., at 3 in FIG. 2A) and perform the serviceability update in response to the vote results determined by the consensus module (e.g., in response to 6 in FIG. 2A). For example, if the serviceability client 262 is included in a topology manager 270 serviceability module, the serviceability client 262 may be configured to provide the consensus module 250 with information identifying neighboring nodes for inclusion in a vote. In response to the vote results indicating a quorum, the serviceability client 262 may update topology information it maintains to reflect the agreed-upon configuration of the cluster.

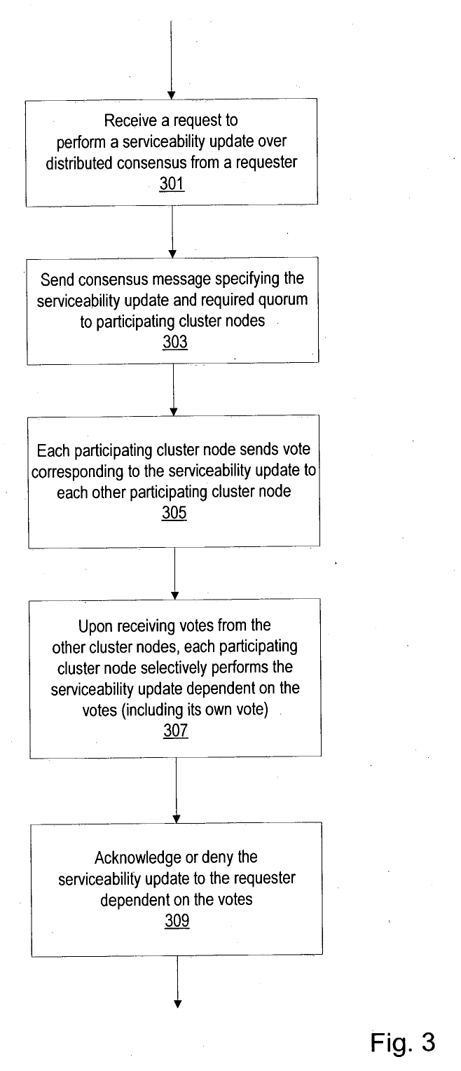

FIG. 3 illustrates one embodiment of a method of performing a cluster serviceability update over distributed consensus. At 301, a request to perform a serviceability update over distributed consensus is received. The request may be a request to define cluster membership, a request to modify a load balancing algorithm, a request to enable or disable an application, etc. At 303, a consensus message specifying the serviceability update and the required quorum needed before performance of the serviceability update may be communicated to (at least) all of the participating nodes. The participating nodes and the required quorum may each be identified in the request received at 301.

At 305, each participating node sends a vote corresponding to the serviceability update to each other participating node. The vote may indicate whether or not the sending node can perform the specified serviceability update. The vote may also include other information specific to the sending node. The votes may be sent according to a reliable multicast protocol in some embodiments. In some embodiments, votes may be sent according to a ring topology.

Upon receiving votes from other participating nodes, each participating node may selectively perform the serviceability update dependent on whether the votes indicate that the required quorum exists and whether that node is part of the quorum, as shown at 307. A participating node may take its own vote into account when determining whether a quorum exists. The quorum may include fewer than all of the participating nodes. If the votes indicate a quorum, and if that node is part of the quorum, then the node may perform the serviceability update.

At 309, the requester receives an acknowledgment or denial of the request for the serviceability update dependent on the votes sent by each participating node at 305. The request may be acknowledged if a quorum exists and denied otherwise.

Various embodiments may further include receiving, sending or storing instructions and/or data implemented in accordance with the foregoing description upon a computer accessible medium. Generally speaking, a computer accessible medium may include storage media or memory media such as magnetic or optical media, e.g., disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals, conveyed via a communication medium such as network and/or a wireless link.

It will be appreciated by those of ordinary skill having the benefit of this disclosure that the illustrative embodiments described above are capable of numerous variations without departing from the scope and spirit of the invention. Various modifications and changes may be made as would be obvious to a person skilled in the art having the benefit of this disclosure. It is intended that the following claims be interpreted to embrace all such modifications and changes and, accordingly, the specifications and drawings are to be regarded in an illustrative rather than a restrictive sense.

What is claimed is:

1. A method, comprising:
receiving a request to perform a cluster serviceability update;
in response to said receiving, requesting a consensus corresponding to the cluster serviceability update from a plurality of nodes included in the cluster;
each of the plurality of nodes communicating at least one vote corresponding to the cluster serviceability update to each other one of the plurality of nodes; and
each of the plurality of nodes selectively performing the cluster serviceability update in response to receiving one or more votes from each other one of the plurality of nodes dependent upon whether a quorum is indicated in the received votes.

2. The method of claim 1, wherein the request to perform the cluster serviceability update specifies a task to be performed and the quorum to be reached before performing the task.

3. The method of claim 2, wherein the quorum to be reached requires agreement from fewer than all of the plurality of nodes.

4. The method of claim 1, wherein the request to perform the cluster serviceability update specifies a list of participating nodes within the cluster.

5. The method of claim 4, wherein the list of participating nodes identifies fewer than all nodes included within the cluster.

6. The method of claim 1, wherein said performing the cluster serviceability update comprises disabling an application served by each of the plurality of nodes.

7. The method of claim 1, wherein said performing the cluster serviceability update comprises enabling an application served by the each of the plurality of nodes.

8. The method of claim 1, wherein said performing the cluster serviceability update comprises updating cluster membership information maintained at each of the plurality of nodes.

9. The method of claim 1, wherein the plurality of nodes are coupled by a wide area network (WAN).

10. The method of claim 1, wherein said selectively performing comprises each of the plurality of nodes selectively performing the cluster serviceability update dependent on information identifying a current load contained in each other node's vote.

11. The method of claim 1, wherein said communicating the vote comprises each of the plurality of nodes communicating the vote upon a communication medium implementing a reliable multicast protocol.

12. The method of claim 1, wherein said communicating the vote comprises each of the plurality of nodes communicating the vote according to a ring topology.

13. A distributed data system cluster, comprising:
a plurality of nodes, wherein each node includes a consensus module and a serviceability module; and
an interconnect coupling the plurality of nodes;
wherein in response to receiving a request to perform a serviceability update from a serviceability module, a consensus module in an initiating node of the plurality of nodes is configured to send a vote request to a consensus module included in each other node in the plurality of nodes;
wherein each consensus module is configured to send a vote to each other consensus module in the plurality of nodes in response to receiving the vote request; and
wherein a consensus module in one of the plurality of nodes is configured to cause a serviceability module included in the one of the plurality of nodes to perform the serviceability update dependent on whether a quorum is indicated by the received votes.

14. The distributed data system cluster of claim 13, wherein the request to perform the serviceability update specifies a task to be performed and the quorum to be reached before performing the task.

15. The distributed data system cluster of claim 14, wherein the quorum to be reached involves fewer than all of the participating nodes.

16. The distributed data system cluster of claim 13, wherein the request to perform the serviceability update specifies a list of participating nodes within the distributed data system cluster.

17. The distributed data system cluster of claim 16, wherein the list of participating nodes identifies fewer than all nodes included within the distributed data system cluster.

18. The distributed data system cluster of claim 13, wherein the consensus module in the one of the plurality of nodes is configured to cause the serviceability module in the one of the plurality of nodes to disable an application served by that node in response to the received votes indicating the quorum.

19. The distributed data system cluster of claim 13, wherein the consensus module in the one of the plurality of nodes is configured to cause the serviceability module in the one of the plurality of nodes to enable an application served by that node in response to the received votes indicating the quorum.

20. The distributed data system cluster of claim 13, wherein the consensus module in the one of the plurality of nodes is configured to cause the serviceability module in the one of the plurality of nodes to update cluster membership information maintained by that node in response to the received votes indicating the quorum.

21. The distributed data system cluster of claim 13, wherein the interconnect comprises a wide area network (WAN).

22. The distributed data system cluster of claim 13, wherein the interconnect implements a reliable multicast protocol.

23. The distributed data system cluster of claim 13, wherein the interconnect implements to a ring communication topology.

24. A device for use in a distributed data system cluster, the device comprising:
a network interface configured to send and receive communications from a plurality of nodes;
a consensus module; and
a serviceability module coupled to communicate with the consensus module;
wherein in response to receiving a request to perform a serviceability update from the serviceability module, the consensus module is configured to send a vote request to each of the plurality of nodes via the network interface;
wherein in response to receiving votes from the plurality of nodes, the consensus module is configured to selectively send an acknowledgment or denial of the request to perform the serviceability update to the serviceability module dependent on whether a quorum is indicated by the received votes.

25. The device of claim 24, wherein the consensus module is further configured to send a vote to each of the plurality of nodes via the network interface in response to sending the vote request.

26. The device of claim 25, wherein the consensus module is further configured to instruct the serviceability module to perform the serviceability update if the received votes indicate the quorum.

27. The device of claim 26, wherein the consensus module is configured to instruct the serviceability module to disable an application in response to the received votes indicating the quorum.

28. The device of claim 26, wherein the consensus module is configured to instruct the serviceability module to enable an application in response to the received votes indicating the quorum.

29. The device of claim 26, wherein the consensus module is configured to instruct the serviceability module to update cluster membership information in response to the received votes indicating the quorum.

30. The device of claim 24, wherein the request to perform the serviceability update specifies a task to be performed and the quorum to be reached before performing the task.

31. The device of claim 30, wherein the quorum to be reached requires agreement from fewer than all of the plurality of nodes.

32. The device of claim 24, wherein the request to perform the serviceability update specifies a list of participating nodes within the distributed data system cluster.

33. The device of claim 32, wherein the list of participating nodes identifies fewer than all of the nodes included within the distributed data system cluster.
